(19) United States
(12) Patent Application Publication
(10) Pub. No.: US 2026/0158873 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yong Hyun Choi, Hwaseong-si (KR); Jung Wu Jung, Hwaseong-si (KR); Yong Woong Cha, Hwaseong-si (KR); Jung-Ho Kwon, Hwaseong-si (KR); Namho Park, Hwaseong-si (KR); Hyeonkeun Yun, Hwaseong-si (KR); Seokjun Oh, Hwaseong-si (KR); Seong-Bin Jeong, Hwaseong-si (KR); Jongwon Kim, Hwaseong-si (KR); Jeong Hun Cha, Hwaseong-si (KR); Jongmin Lee, Hwaseong-si (KR); Seongeun Kim, Hwaseong-si (KR); Joonho Kim, Hwaseong-si (KR); Jae Sik Choi, Hwaseong-si (KR); Hyo Chan Bae, Hwaseong-si (KR); Young Tae Song, Hwaseong-si (KR)

(73) Assignees: HYUNDAI MOTOR COMPANY, Seoul (KR); KIA CORPORATION, Seoul (KR)

(21) Appl. No.: 19/208,295

(22) Filed: May 14, 2025

(30) Foreign Application Priority Data
Dec. 6, 2024 (KR) 10-2024-0181002

(51) Int. Cl. B60H 1/32

(52) U.S. Cl. CPC B60H 1/32284

(57) ABSTRACT

A heat pump system for a vehicle capable of improving the overall efficiency of the system as well as simplifying the system is disclosed. The heat pump system adjusts the temperature of a battery module by using a single chiller where the refrigerant and the coolant are heat-exchanged, recollects waste heat of the electrical components and the battery module for heating of the vehicle, and forms a plurality of coolant flowing lines by using a single valve according to a selected mode of the vehicle.

### CROSS-REFERENCE TO RELATED APPLICATION

This application claims priority to and the benefit of Korean Patent Application No. 10-2024-0181002 filed with the Korean Intellectual Property Office on Dec. 6, 2024, the entire contents of which are incorporated herein by reference.

### BACKGROUND

### Technical Field

The present disclosure relates to a heat pump system for a vehicle. More particularly, the present disclosure relates to a heat pump system for a vehicle capable of adjusting the temperature of a battery module by using a single chiller where the refrigerant and the coolant are heat-exchanged, recollecting waste heat of the electrical components and the battery module and using it for heating of the vehicle, and forming a plurality of coolant flowing lines by a single valve according to selected mode of the vehicle.

### Description of the Related Art

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode.

Recently, in accordance with a continuous increase in interest in energy efficiency and an environmental pollution problem, the development of an environmentally-friendly vehicle capable of substantially substituting for an internal combustion engine vehicle is required The environmentally-friendly vehicle is classified into an electric vehicle driven using a fuel cell or electricity as a power source and a hybrid vehicle driven using an engine and a battery.

In the electric vehicle or the hybrid vehicle among these environmentally-friendly vehicles, a separate heater is not used unlike an air conditioner of a general vehicle, and an air conditioner used in the environmentally-friendly vehicle is called a heat pump system.

The electric vehicle generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in the hybrid vehicle or the electric vehicle according to the related art, cooling means, a heat pump system, and a battery cooling system, respectively, should be configured as separate closed circuits so as to prevent heat generation of or in the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort.

In addition, when heating the vehicle interior, the heating performance may be deteriorated due to the lack of a heat source, the electricity consumption may be increased due to the usage of the electric heater, and the power consumption of the compressor may be increased.

In addition, a separate heat-exchanger is additionally required in order to recollect waste heat from various heat sources in the heating mode of the vehicle, which results in the disadvantage of increasing manufacturing costs.

The above information disclosed in this Background section is only for enhancement of understanding of the background, and therefore it may contain information that does not form the prior art that is already known in this country to those having ordinary skill in the art.

### SUMMARY

The present disclosure provides a heat pump system for a vehicle capable of enhancing the overall efficiency of the system by adjusting a temperature of a battery module by using a single chiller where a refrigerant and a coolant are heat-exchanged, and by selectively recollecting waste heat of an electrical component and the battery module and using the same for heating of the vehicle interior.

In addition, the present disclosure provides a heat pump system for a vehicle capable of simplifying a layout of the system and reducing manufacturing costs by forming a plurality of coolant flowing lines using a single valve according to a selected mode of the vehicle.

A heat pump system may include a valve module configured to control a flow rate of a coolant that is interiorly introduced according to at least one mode for a temperature adjustment of a vehicle interior, and a temperature adjustment of a battery module. The heat pump system further includes a first line connected to the valve module to selectively flow the coolant, and provided with an electrical component. The heat pump system further includes a second line having a first end connected to the first line and a second end connected to the valve module to selectively flow the coolant, and provided with a radiator. The heat pump system further includes a third line connected to the valve module to selectively flow the coolant, and provided with the battery module. The heat pump system further includes a fourth line having a first end connected to the valve module to selectively flow the coolant and a second end connected to the third line. The heat pump system further includes a fifth line having a first end connected to the valve module to selectively flow the coolant and a second end connected to a chiller. The heat pump system further includes a sixth line having a first end connected to the first line at a position where the first line and the second line are connected, and configured to selectively flow the coolant. The heat pump system further includes a seventh line having a first end connected to the third line at a position where the third line and the fourth line are connected, and configured to selectively flow the coolant. The heat pump system further includes an eighth line having a first end connected to the valve module to selectively flow the coolant and a second end connected to the first line at a downstream end of the electrical component, wherein a second end of the sixth line and a second end of the seventh line are respectively connected to the chiller such that the sixth line and the seventh line may be connected to the fifth line through the chiller.

The valve module may include a valve configured to control the flow rate of the coolant that is interiorly introduced, and at least one water pump provided in the valve.

The at least one water pump may include a first water pump mounted on the valve to correspond to the first line, and a second water pump mounted on the valve to correspond to the third line.

The first water pump and the second water pump may be disposed at positions facing each other with respect to the valve.

The first water pump and the second water pump may be formed as pumps with different pumping heads to control the flow rate of coolant in the at least one mode.

The first water pump and the second water pump may be operated at different revolutions per minute (RPM) to control the flow rate of coolant in the at least one mode.

The valve selectively may discharge the coolant selectively flowing from the second line, or the fourth line, or the fifth line or the eighth line through the first line or the third line depending on a selected mode from among the at least one mode.

The at least one mode may include a first mode for cooling the electrical component and the battery module by using the coolant cooled at the radiator, a second mode for recollecting a waste heat of the battery module while heating the vehicle interior or for cooling the battery module using the coolant heat-exchanged in the chiller while cooling the vehicle interior, a third mode for heating the battery module by recollecting a waste heat from the electrical component, and a fourth mode for heating the vehicle interior and recollecting the waste heat of the electrical component.

In the first mode, the second line may be connected to the third line by an operation of the valve module such that the coolant cooled at the radiator is supplied to the electrical component and the battery module, the fourth line may be connected to the first line by the operation of the valve module, the first line, the second line, the third line, and the fourth line may be interconnected by the operation of the valve module such that the coolant may circulate along the first line, the second line, the third line, and the fourth line, and the fifth line and the eighth line may be closed by the operation of the valve module.

The sixth line and the seventh line may be opened when the flow rate of coolant supplied to the battery module through the third line is greater than the flow rate of coolant supplied to the electrical component through the first line.

The sixth line and the seventh line may be closed when the flow rate of coolant supplied to the battery module through the third line is equal to the flow rate of coolant supplied to the electrical component through the first line.

In the second mode, the second line may be connected to the first line by an operation of the valve module such that the coolant cooled at the radiator is supplied to the electrical component, the fifth line may be connected to the third line by the operation of the valve module, the seventh line may be opened to be connected to the third line and the chiller, the fourth line and the eighth line may be closed by the operation of the valve module, the sixth line may be closed, the first line and the second line may form a first independent closed circuit by the operation of the valve module, and the third line, the fifth line, and the seventh line may form a second independent closed circuit by the operation of the valve module.

When cooling the vehicle interior, the chiller may cool the coolant supplied to the battery module by heat-exchanging the refrigerant and the coolant.

When heating the vehicle interior, the chiller may recollect the waste heat of the battery module from the coolant heated while cooling the battery module.

In the third mode, a portion of the first line may be opened by an operation of the valve module such that the coolant having passed through the electrical component is introduced into the eighth line, a remaining portion of the first line connected to the second line at a downstream end of the electrical component may be closed, the second line may be closed by the operation of the valve module, the fourth line may be closed by the operation of the valve module, the fifth line may be connected to the first line by the operation of the valve module, the sixth line may be closed, the seventh line may be opened and connected to the fifth line through the chiller, the eighth line may be connected to the third line by the operation of the valve module, the portion of the first line, the third line, the fifth line, the seventh line, and the eighth line may be interconnected by the operation of the valve module, and the coolant heated while cooling the electrical component may be supplied to the battery module.

In the fourth mode, the second line may be closed by an operation of the valve module such that the coolant having passed through the electrical component is not supplied to the radiator, the fifth line may be connected to the first line by the operation of the valve module, the sixth line may be opened to be connected to the first line and the chiller, the third line and the fourth line may be closed by the operation of the valve module, the seventh line may be closed, the eighth line may be closed by the operation of the valve module, the first line, the fifth line, and the sixth line may be interconnected by the operation of the valve module, and the chiller may recollect the waste heat of the electrical component from the coolant heated while cooling the electrical component.

The valve module may further include a reservoir tank provided in the valve, and may be connected to the second line.

The chiller may be connected to an air conditioner unit through a refrigerant connection line.

The chiller may be a water-cooled heat-exchanger that heat-exchanges an interiorly introduced coolant with a refrigerant supplied from the air conditioner unit.

According to a heat pump system for a vehicle according to an embodiment, the overall efficiency of the system may be enhanced by adjusting a temperature of a battery module by using a single chiller where a refrigerant and a coolant are heat-exchanged, and by selectively recollecting waste heat of the electrical component and the battery module and using the same for heating of the vehicle.

In addition, according to the present disclosure, streamlining and simplification of the system may be achieved while reducing manufacturing costs by forming a plurality of coolant flowing lines by a single valve according to selected mode of the vehicle.

In addition, according to an embodiment, by efficiently adjusting the temperature of the battery module, the optimal performance of the battery module may be enabled, and the overall travel distance of the vehicle may be increased due to the efficient management of the battery module.

In addition, according to an embodiment, by using waste heat of the electrical component to heat the battery module, the coolant heater that was previously applied to heat up the battery module may be eliminated.

In addition, according to an embodiment, it is possible to reduce manufacturing cost and weight through simplification of an entire system, and to improve space utilization.

### BRIEF DESCRIPTION OF THE DRAWINGS

FIG. 1 is a block diagram of a heat pump system of a vehicle according to an embodiment.

FIG. 2 is an operation diagram of a first mode of a heat pump system of a vehicle according to an embodiment.

FIG. 3 is an operation diagram of a second mode of a heat pump system of a vehicle according to an embodiment.

FIG. 4 is an operation diagram of a third mode of a heat pump system of a vehicle according to an embodiment.

FIG. 5 is an operation diagram of a fourth mode of a heat pump system of a vehicle according to an embodiment.

### DETAILED DESCRIPTION

An embodiment is hereinafter described in detail with reference to the accompanying drawings.

Embodiments disclosed in the present specification and the constructions depicted in the drawings are only example embodiments of the present disclosure, and do not cover the entire scope of the present disclosure. Therefore, it is understood that there may be various equivalents and variations at the time of the application of this specification.

In order to clarify the present disclosure, parts that are not related to the description are omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, and the like, are exaggerated for clarity.

In addition, unless explicitly described to the contrary, the word “comprise” and variations such as “comprises” or “comprising”, is understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, unit, device, element, or the like of the present disclosure is described as having a purpose or performing an operation, function, or the like, the component, unit, device, or element should be considered herein as being “configured to” meet that purpose or to perform that operation or function.

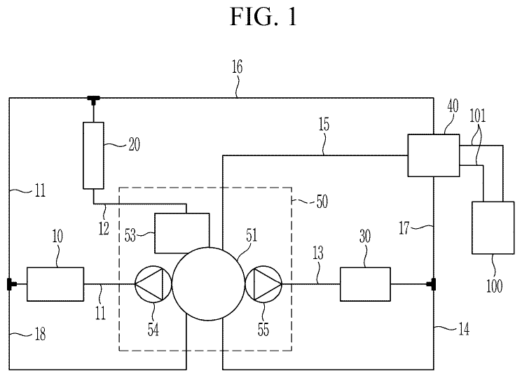

FIG. 1 is a block diagram of a heat pump system of a vehicle according to an embodiment.

A heat pump system for a vehicle according to an embodiment may efficiently adjust the temperature of a battery module 30 by using a single chiller 40 where a refrigerant and a coolant are heat-exchanged, and selectively recollect waste heat of an electrical component 10 and the battery module 30 and by using the same for heating of the vehicle interior, thereby enhancing the overall efficiency of the system.

In addition, according to the heat pump system, the layout of the system may be simplified, and the manufacturing costs may be reduced, by forming plurality of coolant lines by using a single a valve 51 according to a selected mode of the vehicle.

According to the heat pump system, the electrical component 10 and the battery module 30 through which the coolant circulates may be interconnected with each other through an air conditioner unit 100 and the chiller 40 for circulating the refrigerant.

In other words, referring to FIG. 1, the heat pump system may include a first line 11, a second line 12, a third line 13, a fourth line 14, a fifth line 15, a sixth line 16, a seventh line 17, an eighth line 18, and a valve module 50.

The valve module 50 may control flow of the coolant that is interiorly introduced, according to at least one selected mode for a temperature adjustment of the vehicle interior and a temperature adjustment of the battery module 30.

A configuration of the valve module 50 is described in more detail below.

In the present embodiment, a first end of the first line 11 may be connected to the valve module 50, and the coolant may selectively flow therethrough. The electrical component 10 may be provided in the first line 11.

A first end of the second line 12 may be connected to a second end of the first line 11. A second end of the second line 12 may be connected to the valve module 50, and the coolant may selectively flow therethrough.

A radiator 20 may be provided in the second line 12. The radiator 20 may be disposed in the front of the vehicle, and a cooling fan (not shown) may be provided at a downstream side of the radiator 20.

Accordingly, the radiator 20 cools the coolant through an operation of the cooling fan and heat-exchanges with ambient air.

In the present embodiment, a first end of the third line 13 may be connected to the valve module 50 to selectively flow the coolant. The battery module 30 may be provided on the third line 13.

A first end of the fourth line 14 may be connected to the valve module 50 to selectively flow the coolant. A second end of the fourth line 14 may be connected to the third line 13.

In the present embodiment, the first end of the fifth line 15 may be connected to the valve module 50 to selectively flow the coolant. A second end of the chiller 40 may be provided in the fifth line 15.

The chiller 40 may be connected to the air conditioner unit 100 through a refrigerant connection line 101. The chiller 40 may be a water-cooled heat-exchanger that heat-exchanges the interiorly introduced coolant with respect to the refrigerant supplied from the air conditioner unit 100.

In other words, the chiller 40 may adjust a temperature of the coolant by heat-exchanging the selectively supplied coolant with the refrigerant selectively supplied from the air conditioner unit 100.

For cooling of the battery module 30, or for heating of the vehicle interior, the chiller 40 may be operated in order to recollect heat from the coolant heated by waste heat of the electrical component 10 or waste heat of the battery module 30.

In the present embodiment, a first end of the sixth line 16 may be connected to the first line 11 at a position where the first line 11 and the second line 12 are connected. The coolant may selectively flow through the sixth line 16 according to the operation of the valve module 50.

A first end of the seventh line 17 may be connected to the third line 13 at a position where the third line 13 and the fourth line 14 are connected. The coolant may selectively flow through the seventh line 17 according to the operation of the valve module 50.

The second end of the sixth line 16 and the second end of the seventh line 17 may be respectively connected to the chiller 40 such that the sixth line 16 and the seventh line 17 may be respectively connected to the fifth line 15 through the chiller 40.

In addition, a first end of the eighth line 18 may be connected to the valve module 50 to selectively flow the coolant. A second end of the eighth line 18 may be connected to the first line 11 at a downstream end of the electrical component 10.

An upstream end of the electrical component 10 and the downstream end of the electrical component 10 may be set based on a flow direction of the coolant.

In other words, based on the direction in which the coolant flows along the first line 11, a location at which the coolant is introduced into the electrical component 10 may be defined as the upstream end of the electrical component 10, and a location at which the coolant is discharged from the electrical component 10 may be defined as the downstream end of the electrical component 10.

In the present embodiment, the valve module 50 may include the valve 51 for controlling the flow of the interiorly introduced coolant, and at least one water pump provided in the valve 51.

The valve module 50 may further include a reservoir tank 53 provided in the valve 51, the reservoir tank 53 being connected to the second line 12.

The at least one water pump may include a first water pump 54 and a second water pump 55.

The first water pump 54 may be mounted on the valve 51 corresponding to the first line 11.

In addition, the second water pump 55 may be mounted on the valve 51 corresponding to the third line 13.

The first water pump 54 and the second water pump 55 may be disposed at positions facing each other, with reference to the valve 50. The first water pump 54 and the second water pump 55 may be electric water pumps.

In addition, the first water pump 54 and the second water pump 55 may be operated at different revolutions per minute (RPM) to control the flow rate of coolant in the at least one mode.

In other words, when the first water pump 54 and the second water pump 55 are the pumps having the same pumping head, the first water pump 54 and the second water pump 55 may operate at different revolutions per minute (RPM) so that the flow rates of the coolant flowed through the first line 11 and the third line 13 are different from each other.

The pumping head refers to a height at which the pump may pump liquid when pumping the liquid.

Conversely, the first water pump 54 and the second water pump 55 may be formed as pumps with different pumping heads to control the flow rate of coolant in the at least one mode.

When the first water pump 54 and the second water pump 55 may be formed as pumps with different pumping heads, the heat pump system may control the flow of coolant only by controlling the operation of the water pump without individually controlling the revolutions per minute of the first and second water pumps (54, 55) in at least one mode.

In the present embodiment, the valve 51 may selectively discharge the coolant selectively flowing from the second line 12, or the fourth line 14, or the fifth line 15 or the eighth line 18 through the first line 11 or the third line 13 depending on a selected mode from among the at least one mode.

The at least one mode may include a first mode to a fourth mode.

The first mode may cool the electrical component 10 and the battery module 30 by using the coolant cooled at the radiator 20.

The second mode may recollect a waste heat of the battery module 30 while heating the vehicle interior or may cool the battery module 30 using coolant heat-exchanged in the chiller 40 while cooling the vehicle interior.

The third mode may heat the battery module 30 recollecting a waste heat from the electrical component 10.

The third mode may recollect the heat required to heat the battery module 30 from the electrical component 10. The third mode may be said to be an inefficient control mode that intentionally operates a drive motor included in the electrical component 10 and utilizes the intentional heat generated from the drive motor.

In addition, in the fourth mode, the vehicle interior may be heated, and the waste heat of the electrical component 10 may be recollected.

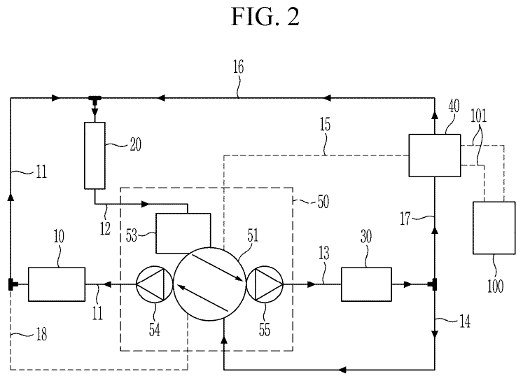

Hereinafter, operation and action in each mode of a heat pump system of a vehicle according to an embodiment configured as described above is described in detail with reference to FIG. 2-5.

First, an operation in the first mode of a heat pump system for a vehicle according to an embodiment, for cooling the electrical component 10 and the battery module 30 by using the coolant cooled at the radiator 20, is described with reference to FIG. 2.

FIG. 2 is an operation diagram of a first mode of a heat pump system of a vehicle according to an embodiment.

Referring to FIG. 2, in the first mode, the second line 12 may be connected to the third line 13 by an operation of the valve 51 such that the coolant cooled at the radiator 20 may be supplied to the electrical component 10 and the battery module 30.

The fourth line 14 may be connected to the first line 11 by the operation of the valve 51.

The fifth line 15 and the eighth line 18 may be closed by the operation of the valve 51.

In addition, the sixth line 16 and the seventh line 17 may be closed when the flow rate of coolant supplied to the battery module 30 through the third line 13 is equal to the flow rate of coolant supplied to the electrical component 10 through the first line 11.

Accordingly, the first line 11, the second line 12, the third line 13, and the fourth line 14 may be interconnected by the operation of the valve 51 such that the coolant may circulate along the first line 11, the second line 12, the third line 13, and the fourth line 14.

In such a state, when the first water pump 54 and the second water pump 55 are both operated, the coolant cooled at the radiator 20 flows into the valve 51 along the second line 12, and then is discharged through the third line 13.

The coolant discharged to the third line 13 may cool the battery module 30 while passing through the battery module 30. The coolant having cooled the battery module 30 flows back into the valve 51 along the fourth line 14.

The coolant introduced into the valve 51 through the fourth line 14 is discharged through the first line 11.

The coolant discharged to the first line 11 may cool the electrical component 10 while passing through the electrical component 10. The coolant having cooled the electrical component 10 flows into the radiator 20 along the second line 12.

The coolant introduced into the radiator 20 may be cooled through heat-exchange with the ambient air.

The air conditioner unit 100 may stop operating.

In other words, while repeatedly performing the above-described processes, the coolant cooled at the radiator 20 may cool the electrical component 10 and the battery module 30 to prevent overheating.

The coolant cooled at the radiator 20 may more efficiently cool the battery module 30 by first passing through the battery module 30 by the operation of the valve module 50.

The sixth line 16 and the seventh line 17 may be opened when the flow rate of coolant supplied to the battery module 30 through the third line 13 is greater than the flow rate of coolant supplied to the electrical component 10 through the first line 11.

In other words, the sixth line 16 and the seventh line 17 may be opened when a greater amount of the coolant than the amount of coolant supplied to the electrical components 10 is supplied to the battery module 30 for rapid cooling of the battery module 30.

Accordingly, the first line 11, the second line 12, the third line 13, the fourth line 14, the sixth line 16, and the seventh line 17 may be interconnected by the operation of the valve 51 such that the coolant may circulate along the first line 11, the second line 12, the third line 13, the fourth line 14, the sixth line 16, and the seventh line 17.

In this case, some of the coolant flowing through the third line 13 may flow along the fourth line 14 and flow into the first line 11 connected through the valve 51.

A law of conservation of mass of a fluid mechanics may be applied to the coolant, which is an incompressible fluid.

Accordingly, the flow rate of the coolant flowing into the fourth line 14 may be the same as the flow rate of the coolant flowing through the first line 11.

Among the coolant flowing through the third line 13, the remaining coolant may flow along the seventh line 17 and the sixth line 16, and flow to the second line 12 together with the coolant flowing to the first line 11.

The flow rate of coolant flowing through the seventh line 17 and the sixth line 16 may be the remaining flow rate excluding the flow rate of coolant flowing through the first line 11 among the coolant flowing through the third line 13.

Through such an operation, the heat pump system may quickly and efficiently cool the battery module 30 by supplying a large amount of coolant to the battery module 30.

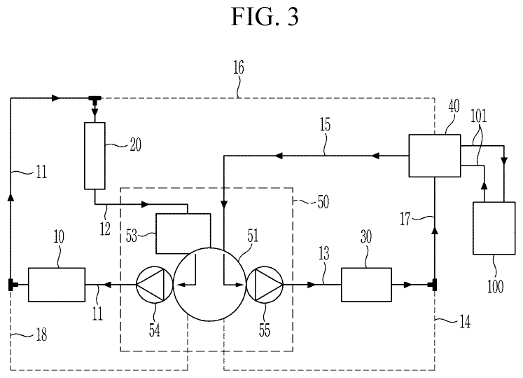

In the present embodiment, an operation in the second mode, for recollecting a waste heat of the battery module 30 while heating the vehicle interior or for cooling the battery module 30 using coolant heat-exchanged in the chiller 40 while cooling the vehicle interior, is described with reference to FIG. 3.

FIG. 3 is an operation diagram of a second mode of a heat pump system of a vehicle according to an embodiment.

Referring to FIG. 3, in the second mode, the second line 12 may be connected to the first line 11 by an operation of the valve 51 such that the coolant cooled at the radiator 20 may be supplied to the electrical component 10.

The fifth line 15 may be connected to the third line 13 by the operation of the valve 51. The seventh line 17 may be opened to be connected to the third line 13 and the chiller 40.

The fourth line 14 and the eighth line 18 may be closed by the operation of the valve 51. In addition, the sixth line 16 may be closed.

Accordingly, the first line 11 and the second line 12 may form a first independent closed circuit by the operation of the valve module 50.

In addition, the third line 13, the fifth line 15, and the seventh line 17 may form a second independent closed circuit by the operation of the valve module 50.

In such a state, when the first water pump 54 is operated, the coolant cooled at the radiator 20 flows into the valve 51 along the second line 12, and then is discharged through the first line 11.

The coolant discharged to the first line 11 may cool the electrical component 10 while passing through the electrical component 10. The coolant having cooled the electrical component 10 flows into the radiator 20 along the second line 12.

When the second water pump 55 is operated, the coolant discharged to the third line 13 may cool the battery module 30 while passing through the battery module 30.

The coolant having cooled the battery module 30 may flow along the opened seventh line 17. The coolant flowing through the seventh line 17 may pass through the chiller 40 and then flow along the fifth line 15.

The air conditioner unit 100 may operate such that the refrigerant may be supplied to the chiller 40 through the refrigerant connection line 101.

When heating of the vehicle interior is required, the chiller 40 may recollect the waste heat of the battery module 30 from the coolant heated while cooling the battery module 30.

In more detail, the coolant heated by absorbing the waste heat of the battery module 30 is recollected while heating the refrigerant supplied to the chiller 40 while passing through the chiller 40.

In other words, the chiller 40 may heat the refrigerant by heat-exchanging the coolant and the refrigerant in order to recollect waste heat from the coolant heated while passing through the battery module 30. The heated refrigerant may be supplied to the air conditioner unit 100.

As such, by repeatedly performing the above-described processes, the coolant cooled at the radiator 20 may efficiently cool the electrical component 10. In addition, the chiller 40 may smoothly recollect the waste heat of the battery module 30.

When cooling of the vehicle interior is required, the chiller 40 may cool the coolant by heat exchanging between the coolant introduced from the battery module 30 through the seven line 17 and the refrigerant supplied from the air conditioner unit 100 through the refrigerant connection line 101.

In other words, when cooling the vehicle interior, the chiller 40 may cool the coolant supplied to the battery module 30 by heat exchanging the refrigerant and the coolant. Accordingly, the coolant cooled in the chiller 40 may efficiently cool the battery module 30 by flowing through the fifth line 15 and the third line 13.

Therefore, in the second mode, when heating the vehicle interior is required, by absorbing the waste heat of the battery module 30 at the chiller 40 and using it for heating the refrigerant, a power consumption of the compressor provided in the air conditioner unit 100 may be decreased, and a heating efficiency thereof may be enhanced.

In addition, when cooling the vehicle interior is required, the second mode may efficiently cool the battery module 30 by quickly cooling the coolant using the refrigerant supplied to the chiller 40 and supplying the cooled coolant to the battery module 30.

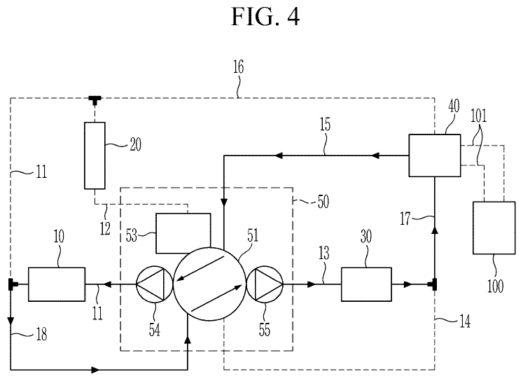

An operation in the third mode of the heat pump system, for heating the battery module 30 by recollecting a waste heat from the electrical component 10, is described with reference to FIG. 4.

FIG. 4 is an operation diagram of a third mode of a heat pump system of a vehicle according to an embodiment.

In the third mode according to the present embodiment, the heat required to heat the battery module 30 may be recollected from the electrical component 10.

For example, if heating of the battery module 30 is required while charging the battery module 30, the heat pump system may intentionally operate the drive motor included in the electric component 10 and increase the temperature of the coolant by using the intentional heat generated by the drive motor.

The coolant heated by this operation may be supplied to the battery module 30 by the operation of the valve module 50 such that the temperature of the battery module 30 is increased.

In this way, the third mode may be said to be an inefficient control mode that intentionally operates a drive motor included in the electrical component 10 and utilizes the heat intentionally generated from the drive motor.

Referring to FIG. 4, a portion of the first line 11 may be opened by the operation of the valve module 50 such that the coolant having passed through the electrical component 10 is introduced into the eighth line 18.

In addition, a remaining portion of the first line 11 connected to the second line 12 at a downstream end of the electrical component 10 may be closed.

The second line 12 may be closed by the operation of the valve 51 such that the coolant having passed through the electrical component 10 is not supplied to the radiator 20.

The fourth line 14 is closed by the operation of the valve module 50 (i.e., by the valve 51).

In the present embodiment, the fifth line 15 may be connected to the first line 11 by the operation of the valve 51.

The sixth line 16 may be closed and the seventh line 17 may be opened.

In other words, the second end of the seventh line 17 may be connected to the chiller 40 such that the seventh line 17 is connected to the fifth line 15 through the chiller 40.

The eighth line 18 may be connected to the third line 13 by the operation of the valve 51.

Accordingly, the portion of the first line 11, the third line 13, the fifth line 15, the seventh line 17, and the eighth line 18 may be interconnected by the operation of the valve module 50.

In such a state, when the first water pump 54 and the second water pump 55 are both operated, the coolant discharged to the first line 11 may pass through the electrical component 10.

The drive motor included in the electrical component 10 may generate heat while being intentionally operated. Therefore, the coolant flowing through the first line 11 may be heated by the heat generated in the electrical component 10.

The coolant heated while passing through the electrical component 10 may flow along the opened eighth line 18. The coolant flowed to the eighth line 18 flows into the valve 51 and then may be discharged to the third line 13.

The coolant discharged to the third line 13 may increase the temperature of the battery module 30 while passing through the battery module 30.

The coolant passing through the battery module 30 may flow into the opened seventh line 17. The coolant flowed to the seventh line 17 passes through the chiller 40 and then is introduced into the valve 51 along the fifth line 15.

Thereafter, the coolant introduced from the fifth line 15 to the valve 51 is discharged to the third line 13 by the operation of the valve 51, and may repeatedly perform above-described processes.

The air conditioner unit 100 may stop operating. Accordingly, the refrigerant connection line 101 may be closed.

In this way, in the third mode, the heat pump system may efficiently increase the temperature of the battery module 30 by rapidly supplying the heated coolant while passing through the electrical component 10 to the battery module 30.

In other words, the third mode may intentionally generate heat through inefficiency control of the drive motor included in the electrical component 10, and use the heat intentionally generated in the electrical component 10 to increase the temperature of the battery module 30.

As a result, the heat pump system may reduce manufacturing cost and weight and reduce electric power consumption by eliminating the high-voltage coolant heater that was previously used for heating the battery module 30.

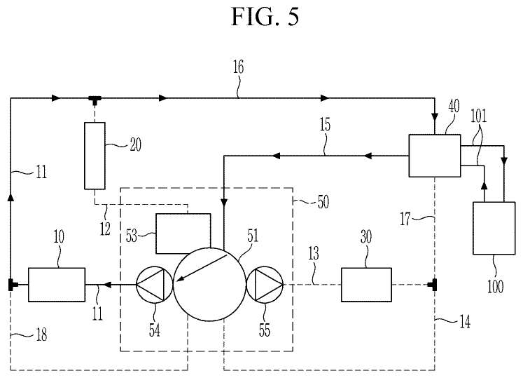

In addition, an operation in the fourth mode of the heat pump system, for heating the vehicle interior and for recollecting the waste heat of the electrical component 10, is described with reference to FIG. 5.

FIG. 5 is an operation diagram of a fourth mode of a heat pump system of a vehicle according to an embodiment.

Referring to FIG. 5, the second line 12 may be closed by the operation of the valve 51 such that the coolant having passed through the electrical component 10 is not supplied to the radiator 20.

The fifth line 15 may be connected to the first line 11 by the operation of the valve 51.

The sixth line 16 may be opened to be connected to the first line 11 and the chiller 40.

In the present embodiment, the third line 13 and the fourth line 14 may be closed by the operation of the valve module 50. At the same time, the seventh line 17 may be closed, and the eighth line 18 may be closed by the operation of the valve module 50.

Accordingly, the first line 11, the fifth line 15, and the sixth line 16 may form an independent closed circuit by the operation of the valve module 50.

In such a state, when the first water pump 54 is operated, the coolant discharged to the first line 11 may cool the electrical component 10 while passing through the electrical component 10.

The coolant having cooled the electrical component 10 may flow along the opened sixth line 16. The coolant flowed to the sixth line 16 may pass through the chiller 40, and then flow along the opened fifth line 15.

Herein, the air conditioner unit 100 may operate such that the refrigerant may be supplied to the chiller through the refrigerant connection line 101.

Then, the chiller 40 may recollect the waste heat of the electrical component 10 from the coolant heated by cooling the electrical component 10.

In more detail, the coolant heated by absorbing the waste heat of the electrical component 10 increases a temperature of the refrigerant supplied to the chiller 40 while passing through the chiller 40.

In other words, the chiller 40 may heat the refrigerant by heat-exchanging the coolant and the refrigerant in order to recollect waste heat from the coolant heated while passing through the electrical component 10. The heated refrigerant may be supplied to the air conditioner unit 100.

As such, by repeatedly performing the above-described processes, the chiller 40 may smoothly recollect the waste heat of the electrical component 10 from the coolant heated by cooling the electrical component 10.

In other words, in the fourth mode, a waste heat of the electrical component 10 is absorbed by the chiller 40 to be used to increase the temperature of the refrigerant, and accordingly, power consumption of the compressor provided in the air conditioner unit 100 is decreased, while improving heating efficiency.

Therefore, according to a heat pump system for a vehicle according to an embodiment, the overall efficiency of the system may be enhanced, by adjusting the temperature of the battery module 30 by using the single chiller 40, and by selectively recollecting and using the waste heat of the electrical component 10 and the battery module 30.

In addition, according to the present disclosure, by forming a plurality of coolant flowing lines by using a single the valve 51 according to the selected mode of the vehicle, streamlining and simplification of the system may be achieved while reducing manufacturing costs.

In addition, according to an embodiment, by efficiently adjusting the temperature of the battery module 30, the optimal performance of the battery module 30 may be enabled, and the overall travel distance of the vehicle may be increased due to the efficient management of the battery module 30.

In addition, according to an embodiment, by using waste heat of the electrical component 10 to heat the battery module 30, the coolant heater that was previously used to heat up the battery module may be eliminated.

In addition, according to an embodiment, it is possible to reduce manufacturing cost and weight through simplification of an entire system, and to improve space utilization.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: electrical component
11, 12, 13: first, second, and third lines
14, 15, 16: fourth, fifth, and sixth lines
17, 18: seventh, and eighth lines
20: radiator
30: battery module
40: chiller
50: valve module
51: valve
53: reservoir tank
54: first water pump
55: second water pump
100: air conditioner unit
101: refrigerant connection line

What is claimed is:

1. A heat pump system, comprising:
a valve module configured to control a flow rate of a coolant according to at least one mode for a temperature adjustment of a vehicle interior and a temperature adjustment of a battery module;
a first line connected to the valve module to selectively flow the coolant, the first line provided with an electrical component;
a second line having a first end connected to the first line and a second end connected to the valve module to selectively flow the coolant, the second line provided with a radiator;
a third line connected to the valve module to selectively flow the coolant, the third line provided with the battery module;
a fourth line having a first end connected to the valve module to selectively flow the coolant and a second end connected to the third line;
a fifth line having a first end connected to the valve module to selectively flow the coolant and a second end connected to a chiller;
a sixth line having a first end connected to the first line at a position where the first line and the second line are connected, and configured to selectively flow the coolant;
a seventh line having a first end connected to the third line at a position where the third line and the fourth line are connected, and configured to selectively flow the coolant; and
an eighth line having a first end connected to the valve module to selectively flow the coolant and a second end connected to the first line at a downstream end of the electrical component,
wherein a second end of the sixth line and a second end of the seventh line are respectively connected to the chiller such that the sixth line and the seventh line are connected to the fifth line through the chiller.

2. The heat pump system of claim 1, wherein the valve module comprises:
a valve configured to control the flow rate of the coolant; and
at least one water pump provided in the valve.

3. The heat pump system of claim 2, wherein the at least one water pump comprises:
a first water pump mounted on the valve to correspond to the first line; and
a second water pump mounted on the valve to correspond to the third line.

4. The heat pump system of claim 3, wherein the first water pump and the second water pump are disposed at positions facing each other with respect to the valve.

5. The heat pump system of claim 3, wherein the first water pump and the second water pump are formed as pumps with different pumping heads to control the flow rate of the coolant in the at least one mode.

6. The heat pump system of claim 3, wherein the first water pump and the second water pump are operated at different revolutions per minute (RPM) to control the flow rate of the coolant in the at least one mode.

7. The heat pump system of claim 2, wherein the valve selectively discharges the coolant selectively flowing from the second line, or the fourth line, or the fifth line or the eighth line through the first line or the third line depending on a selected mode from among the at least one mode.

8. The heat pump system of claim 1, wherein the at least one mode comprises:
a first mode for cooling the electrical component and the battery module by using the coolant cooled at the radiator;
a second mode for recollecting a waste heat of the battery module while heating the vehicle interior or for cooling the battery module using the coolant heat-exchanged in the chiller while cooling the vehicle interior;
a third mode for heating the battery module by recollecting a waste heat from the electrical component; and
a fourth mode for heating the vehicle interior and recollecting the waste heat of the electrical component.

9. The heat pump system of claim 8, wherein, in the first mode:
the second line is connected to the third line by an operation of the valve module such that the coolant cooled at the radiator is supplied to the electrical component and the battery module;
the fourth line is connected to the first line by the operation of the valve module;
the first line, the second line, the third line, and the fourth line are interconnected by the operation of the valve module such that the coolant circulates along the first line, the second line, the third line, and the fourth line; and
the fifth line and the eighth line are closed by the operation of the valve module.

10. The heat pump system of claim 9, wherein the sixth line and the seventh line are opened when the flow rate of the coolant supplied to the battery module through the third line is greater than the flow rate of the coolant supplied to the electrical component through the first line.

11. The heat pump system of claim 9, wherein the sixth line and the seventh line are closed when the flow rate of the coolant supplied to the battery module through the third line is equal to the flow rate of the coolant supplied to the electrical component through the first line.

12. The heat pump system of claim 8, wherein, in the second mode:
the second line is connected to the first line by an operation of the valve module such that the coolant cooled at the radiator is supplied to the electrical component;
the fifth line is connected to the third line by the operation of the valve module;
the seventh line is opened to be connected to the third line and the chiller;
the fourth line and the eighth line are closed by the operation of the valve module;
the sixth line is closed;
the first line and the second line form a first independent closed circuit by the operation of the valve module; and
the third line, the fifth line, and the seventh line form a second independent closed circuit by the operation of the valve module.

13. The heat pump system of claim 12, wherein when cooling the vehicle interior, the chiller cools the coolant supplied to the battery module by heat-exchanging a refrigerant and the coolant.

14. The heat pump system of claim 12, wherein when heating the vehicle interior, the chiller recollects the waste heat of the battery module from the coolant heated while cooling the battery module.

15. The heat pump system of claim 8, wherein, in the third mode:
a portion of the first line is opened by an operation of the valve module such that the coolant passing through the electrical component is introduced into the eighth line;
a remaining portion of the first line connected to the second line at a downstream end of the electrical component is closed;
the second line is closed by the operation of the valve module;
the fourth line is closed by the operation of the valve module;
the fifth line is connected to the first line by the operation of the valve module;
the sixth line is closed;
the seventh line is opened and connected to the fifth line through the chiller;
the eighth line is connected to the third line by the operation of the valve module;
the portion of the first line, the third line, the fifth line, the seventh line, and the eighth line are interconnected by the operation of the valve module; and
the coolant heated while cooling the electrical component is supplied to the battery module.

16. The heat pump system of claim 8, wherein, in the fourth mode:
the second line is closed by an operation of the valve module such that the coolant passing through the electrical component is not supplied to the radiator;
the fifth line is connected to the first line by the operation of the valve module;
the sixth line is opened and connected to the first line and the chiller;
the third line and the fourth line are closed by the operation of the valve module;
the seventh line is closed;
the eighth line is closed by the operation of the valve module;
the first line, the fifth line, and the sixth line are interconnected by the operation of the valve module; and
the chiller recollects the waste heat of the electrical component from the coolant heated while cooling the electrical component.

17. The heat pump system of claim 2, wherein the valve module further comprises a reservoir tank provided in the valve, the reservoir tank being connected to the second line.

18. The heat pump system of claim 1, wherein the chiller is connected to an air conditioner unit through a refrigerant connection line.

19. The heat pump system of claim 18, wherein the chiller is a water-cooled heat-exchanger that heat-exchanges an interiorly introduced coolant with a refrigerant supplied from the air conditioner unit.
